(19) United States
(12) Patent Application Publication
(10) Pub. No.: US 2012/0214395 A1
(43) Pub. Date: Aug. 23, 2012

(54) AIR CONDUCTION CHANNEL FOR AN IONIZATION DEVICE

(76) Inventors: Thomas RAIS, Marbach-Neckar (DE); Eric PITZ, Stuttgart (DE)

(21) Appl. No.: 13/401,378

(22) Filed: Feb. 21, 2012

Related U.S. Application Data
(63) Continuation of application No. PCT/EP2010/061500, filed on Aug. 6, 2010.

(30) Foreign Application Priority Data
Aug. 21, 2009 (DE) DE 102009038298.4

(51) Int. Cl. B60H 1/34; H01B 5/00; H01T 23/00; F16L 9/00

(52) U.S. Cl. 454/152; 138/177; 174/47; 361/230

(57) ABSTRACT

An air conduction channel for an ionization device is provided, whereby at least some parts of the air conduction channel have a locally active field compensation component.

This nonprovisional application is a continuation of International Application No. PCT/EP2010/061500, which was filed on Aug. 6, 2010, and which claims priority to German Patent Application No. DE 10 2009 038 298.4, which was filed in Germany on Aug. 21, 2009, and which are both herein incorporated by reference.

### BACKGROUND OF THE INVENTION

1. Field of the Invention

The invention relates to an air conduction device, in particular an air conduction channel and/or an air outlet nozzle, preferably an air conduction device for an ionization device. The invention also concerns an ionization device and a climate control system, in particular a motor vehicle climate control system.

2. Description of the Background Art

In order to satisfy automobile buyers' demands for comfort in connection with motor vehicle ventilation, which have risen over the years, the functionality and complexity of motor vehicle climate control systems have expanded accordingly.

Thus, climate control systems have in the meantime become commonplace in all vehicle classes. The fresh air to be supplied to the vehicle passenger compartment can be heated with such motor vehicle climate control systems. Nowadays, however, a cooling function is usually provided as well, by means of which the fresh air to be supplied to the passenger compartment can also be cooled.

Additional functions that have been implemented in the meantime to an increasing extent in the ventilation of motor vehicles include, for example, filters that are used to clean the fresh air to be supplied to the vehicle passenger compartment and/or to remove unwanted odors (in particular, odors in the outside air).

For some time, ionization devices have also been built into motor vehicles as original equipment. On the one hand, the ionization devices are intended to provide air freshening, which is to say a perception that “fresh air” is present. On the other hand, ionization devices are used to kill pathogens (in particular, bacteria and/or viruses) which may be present in the fresh air and/or recirculated air to be supplied to the vehicle passenger compartment. A combination of a positively charged electrode and a negatively charged electrode is generally used to kill pathogens. In this regard, HO₂⁻ is frequently used as an active ion. To generate HO₂⁻, H⁺ is generated using a positively charged electrode from water (H₂O) present in the form of humidity, and is then reduced to H at the negatively charged electrode. H then combines with O₂⁻ to form active HO₂⁻.

For air freshening, in contrast, negatively charged (single) high-voltage electrodes are usually used, which reduce oxygen molecules (O₂) that are contained in the air to be supplied into negatively charged oxygen ions (O₂⁻).

For the ionization devices to be able to be effective, it is not only necessary for them to generate ions, but also for the ions generated by the ionization devices to remain present for a relatively long period of time, and as a rule to be released into the passenger compartment to be ventilated, as well. This is a problem in the motor vehicle field in particular, where the processed air is directed over a relatively large number of air deflection elements, air control flaps, and outlet nozzles before the processed air is discharged into the vehicle passenger compartment. Tests have shown that an initially sufficient concentration of ions can decrease by more than a factor of 10 within a few minutes. This reduces the effectiveness of air ionization and makes suitable countermeasures necessary.

For example, JP 20063492989A proposes providing a flexible air hose of a climate control system that has an ionization device with a continuous, electrically conductive coating. The electrically conductive coating is grounded. The proposed construction is intended to prevent the ions flowing through the hose from being electrically neutralized and thus being lost.

A method is described in JP 2004-79471 A in which the loss of already generated anions in an air duct following the ionization device is to be prevented. To this end, it is proposed that the ionization device is switched off for approximately 3 to 7 minutes after continuous operation over a period of 10 to 40 minutes.

WO 2009/045430 A1 proposes various organic polymer compositions, which are provided with a metallic coating, for use as air ducts in motor vehicles.

Although the measures already proposed are in principle suitable for reducing the described problem of the loss of already generated ions, the methods and devices already proposed still have a wide variety of problems, such as high costs, insufficient effectiveness, and excessive neutralization of already generated ions, for example.

### SUMMARY OF THE INVENTION

It is therefore an object of the invention to propose an air conduction device that is especially suitable as an air conduction device for an ionization device and has advantages over conventional air conduction devices. Another object of the invention is to propose an ionization device that is improved over conventional ionization devices.

In an embodiment, it is thus proposed to design an air conduction device, in particular an air conduction channel and/or an air outlet nozzle, preferably an air conduction device for an ionization device (for example, an air conduction channel and/or an air outlet nozzle for an ionization device) in such a manner that the air conduction device has a locally acting field compensation component, at least in sections. Ionization devices with various types of construction are known. For example, ionization devices can have a suitably designed electrode to which a negative high voltage is applied. The electrode then releases negatively charged ions, which is to say so-called anions. As a general rule, air containing negative ions is perceived as “fresh air.” Accordingly, it is also common to speak of a so-called “relax mode.” Additionally or as an alternative, it is possible for an ionization device to also have an appropriately formed electrode to which a positive high voltage is applied. Accordingly, the high-voltage electrode that is positively charged in this way emits positively charged ions, which are called cations. The cations generated (for example H⁺ ions) can combine with other molecules and/or ions (for example with O₂⁻ ions to form HO₂⁻ ions), which for their part can have purifying (e.g., bactericidal) action. For this reason, a “clean mode” is spoken of here. Of course, it is also possible for multiple electrodes (either with the same high-voltage supply or with different high-voltage supplies) to be provided. Typically, ionization devices are operated such that exclusively, or at least predominantly, ions of a specific ion type are generated—which is to say, for example, anions, particularly O₂⁻ ions or HO₂⁻ ions—are generated (even when the ionization device possesses electrodes of different designs). As a general rule, this causes an electrostatic charging of components (especially air conduction devices such as air conduction channels and/or air outlet nozzles) that follow the ionization device (in particular the actual ionization component) as viewed in the direction of air flow. The corresponding component surfaces become charged because of the ions contained in the air flow. This results in electric fields, which in turn have effects on the air flow, in particular on the ions contained in the air flow. The result is a highly complex dynamic configuration that can hardly even be described numerically. However, as a general rule the different dynamic charge distributions cause an “obstruction” to the ions carried along in the air stream (usually because the ions are deflected and are subsequently annihilated by contact with a wall).

Experiments have shown that a drastic reduction in the ion concentration ultimately released into a vehicle passenger compartment can result after only a few minutes. Surprisingly, the length of time after which a significant loss of released air ions (up to a factor of 10 and higher) can occur here is significantly shorter than has been assumed heretofore. Tests have shown that the reduction in released ions by more than a factor of 10 is achieved after only 1 to 5 minutes. Accordingly, it is also necessary with typical operating cycles in a motor vehicle (for example, in an automobile) to provide appropriate countermeasures that work against the above-described reduction in the number of ions released in the vehicle passenger compartment. For this purpose, the provision of at least one locally acting field compensation component, at least in sections, is proposed here. With the aid of the at least one locally acting field compensation component that is proposed, it is possible in particular to allow a local field compensation of electric fields, at least at certain times and/or at least in sections, with the aid of image charges. It is especially advantageous in this regard when the locally acting field compensation component is or are designed as passively acting, locally acting field compensation component, so that no complicated control electronics is required and/or no energy need be supplied to operate the field compensation component (or the multiple field compensation component that may be present if applicable), for example.

The inventors have discovered to their own surprise that it is not materials that are especially good conductors applied with full area coverage, and/or surfaces that are especially good insulators, that result in an especially high concentration of ions that are ultimately released (for example, into a vehicle passenger compartment). Instead, it has been found that especially high ion emission can occur when the components following the ionization device (especially components of the locally acting field compensation component) have a relatively low electrical conductivity across relatively long distances and/or have a relatively high electrical conductivity in a small area. In this way, electric field compensation that acts only locally can be achieved, in contrast to which no electric field compensation (or only a small or slow acting, and thus as a general rule “lagging” electric field compensation) can take place in a large area. In contrast, large and highly electrically conductive coatings can only average out inhomogeneous charging, which opposes an electric field compensation that acts only locally. The size of the local structures here is typically in a range of a few centimeters (or square centimeters), for example with typical lengths and/or widths of 0.5 cm, 1 cm, 1.5 cm, 2 cm, 3 cm, 4 cm, or 5 cm. As a result of the fact that, with the aid of an air conduction device according to the proposed design, an especially large fraction of ions can be conducted through the air conduction device without said ions being annihilated, it is possible to make the ionization device smaller and more compact, for example, and also, if applicable, to reduce the required power consumption of the ionization device. In this way, it is possible in turn to implement an especially effective complete system.

It has proven to be especially advantageous for at least one locally acting field compensation component to be designed, at least in sections, as a plurality of electrically conductive material segments. The material segments can be metal plates, metal blocks, or similar components, for example. Such a locally acting field compensation component has only a small tendency to annihilate ions, while at the same time having a relatively simple and economical construction. The size dimensions for the proposed design of the electrically conductive material segments (in particular with regard to their length and/or width) are typically in a range of up to 0.5 cm, 1 cm, 1.5 cm, 2 cm, 3 cm, 4 cm or 5 cm. It is a matter of course that the plurality of electrically conductive sections can be designed in any desired manner. For example, it is possible to apply previously separated material segments to the air conduction device (such as an air conduction channel or air outlet nozzle, for example). (This is, of course, also possible for parts of the air conduction device.) In like manner, however, it is equally possible to provide a metal coating on the full area of the air conduction device and then carry out a local structuring by material-removing methods, for example. The locally acting field compensation component can also be implemented on the outside, the inside, and/or in a middle layer of the air conduction device. Apart from that, it should also be possible for the proposed design to gain protection even without the term “locally acting field protection means.”

The electrical conductivity of at least one electrically conductive material segment can be greater than or equal to 10⁴ S/m, 10⁵ S/m, and/or 10⁶ S/m (S stands for siemens, and m for meter). Such electrical conductivities have proven to be able to achieve an especially good local field compensation.

At least two locally acting field compensation components, in particular at least two electrically conductive material segments, in the air conduction device can be electrically decoupled from one another. In this way it is especially simple to limit the field compensation to local effects. The effectiveness of the proposed air conduction device can be increased by this means. In the simplest case, the electrical decoupling can be accomplished here by an interruption in the electrically conductive material, in particular when the support material (for example, the material of the air conduction device) has a relatively low conductivity.

It has proven to be advantageous for the electrical decoupling of the at least two locally acting field compensation component to have a conductivity less than or equal to 10⁵ S/m, 10⁴ S/m, 10³ S/m, 10² S/m, 10¹ S/m, and/or 10⁰ S/m. The stated relatively low electrical conductivities have proven to be especially suitable for the air conduction device proposed herein.

Additionally or as an alternative, it is also possible for at least one locally acting field compensation component to be designed, at least in sections, as a continuous, slightly electrically conductive component. For example, so-called ESD films (ESD stands for Electro Static Discharge or similar components can be used here. It has also been shown here that such components are particularly suitable as local field compensation component, and that an especially high fraction of the ions generated are “allowed to pass through” by the corresponding components. Nonetheless, the construction of the corresponding ionization device can still be relatively simple and economical. In particular, it should be noted that the installation of the corresponding components (such as the ESD film, for example) can be designed to be especially simple, since these components can be applied as single, large surfaces. This can simplify the production of the air conduction device still further. Naturally, any desired slightly electrically conductive components can be used (and not only ESD films). For example, a coating of plastic material (with the aid of dipping or other coating methods) or an appropriate slightly conductive plastic layer (in particular, when a multi-stage plastic injection molding process is used) can be used. In conjunction with the design of the air conduction device proposed herein, it should also be possible for the proposed design to gain protection even without the term “locally acting field protection means.”

Alternatively, the action of the slightly electrically conductive component can be achieved by a coating of the same type applied by spraying or painting, for example on the inside or the outside of the air conduction channel, or on both the inside and the outside. Alternatively, in another embodiment an additive could be added to the basic material so that the material acquires a slight electrical conductivity.

It is preferred but not required that the air conduction channel that has been thus treated or equipped with the slightly electrically conductive component can be connected to a ground potential through a conductive connection in order to be able to carry away a charge that arises, if applicable.

It has proven to be especially advantageous for at least one slightly electrically conductive component to have, at least in sections, an electrical conductivity less than or equal to 10⁵ S/m, 10⁴ S/m, 10³ S/m, 10² S/m, 10¹ S/m, 10⁰ S/m, 10⁻¹ S/m, 10⁻² S/m, 10⁻³ S/m, 10⁻⁴ S/m, or 10⁻⁵ S/m. The use of materials with the stated conductivities has proven to be especially suitable in initial tests.

In an embodiment, at least one locally acting field compensation component, in particular at least one electrically conductive material segment and/or at least one slightly electrically conductive component, can be designed to be flat, preferably in the form of a film. Initial tests have shown that for the locally acting field compensation component, as a general rule their depth (especially their component dimensions in a direction perpendicular to the direction of air flow) is not (or is only slightly) important. Thus, using a flat or film-type construction it is possible to design a highly effective device with low material usage (and consequently low weight and/or low costs). In case of a flat design of components and/or films, typical thicknesses are in the range of 0.1 mm.

Another embodiment of the air conduction device also results when at least one locally acting field compensation component, in particular at least one electrically conductive material segment and/or at least one slightly electrically conductive component, is implemented to be self-adhesive. With such a construction, especially simple installation of the locally acting field compensation component on the air conduction device (as for example on an air conduction channel, an air outlet nozzle, and on other assemblies as well if applicable) can be realized. Moreover, it should be noted that at the present time metal films and/or ESD films, for example, are already commercially available in large quantities, frequently in self-adhesive form. In this way a further cost reduction can be achieved, and an implementation of the air conduction device proposed herein can take place especially rapidly.

Furthermore, an ionization device is proposed that has at least one ionization component for releasing ions of a first ion type, at least at certain times, and has at least one air conduction device with the structure described above. An ionization device implemented in such a manner can make it possible for an especially high fraction of the ions generated by the ionization device to arrive at the actual “destination” (thus in particular being released into a vehicle passenger compartment). In this way, the overall ionization device can be constructed in an especially simple, economical, and effective manner. For example, since an especially large fraction of the ions generated by the ionization device “survives,” a specific ion concentration can be achieved at the actual air outlet even when only low ion concentrations as compared to prior art ionization devices are generated at the location of the ionization device. In this way, it is possible in particular for the ionization device to be made smaller, less powerful, lighter, and lower in energy consumption.

The effectiveness of the ionization device proposed herein can be further increased significantly when it is designed and configured such that it can be operated in at least one regeneration mode, at least at times. During the regeneration phases, it is definitely possible to accept that during a certain period of time—as short as possible—the (actual) desired concentration mixture and/or the concentration of the ions released into the vehicle passenger compartment changes. It is even conceivable that the number of released ions (at least for certain ion types) will briefly return to zero. Nonetheless, it is possible despite (or thanks to) the insertion of such regeneration phases to increase the average quantity of released ions over time or to bring the concentration ratio of the ions released into the vehicle passenger compartment especially close to the desired target value. In particular, it is possible by this means that a comparatively high concentration of ions can be discharged into the vehicle passenger compartment during the “active” phases that lie between the regeneration phases. With the proposed refinement, it is possible in particular to further increase the effectiveness of the ionization device to a significant degree. As a general rule, the regeneration phase has less of an effect on the actual ionization component here, instead having much more of an effect on the components following the ionization component in the air stream (thus in particular on the air conduction devices such as air conduction channels and/or air outlet nozzles, for example).

The ionization device can, in particular, be operated such that in at least one regeneration mode, ions of a second type different from the first ion type are released at least at times, and/or no ions, in particular no ions of the first ion type, are released at least at times. An ion type can mean a different sign of the charge. Hence, if for example the ions of the first type are anions, then the ions of the second type can accordingly be cations (which if applicable can also be present only temporarily in the form of an “intermediate stage”). Additionally or as an alternative, however, the ions can have only a different charge (for example, one, two, three, etc., times the elementary charge). In particular, they can additionally or alternatively be different molecules that are or have been ionized (as, for example, the above-described ions O₂⁻ and HO₂⁻). Especially when ions with opposite charge are released during the regeneration mode, the regions of the components following the actual ionization component that may already be electrically charged can be discharged by the placement of opposite charge carriers. It is also possible to generate a sort of opposite advance charge distribution, so that during a first operating phase of the ionization device that follows the regeneration phase the components following the actual ionization component are first discharged, and only thereafter are charged again by the ions of the first ion type. Especially when a regeneration takes place using ions of a second ion type, the duration of the regeneration phase typically can be in a range between 5 and 30 seconds, whereas the “normal” operating period is in an interval between 30 seconds and 3 minutes. The ions of the second ion type can be released at least in addition, and/or at least alternately in time, to the ions of the first ion type here. It is thus possible that (at least at certain times) during the regeneration phase, primarily (or exclusively) ions of the second ion type are released. In this case, the duration of the regeneration phase can typically be kept especially short. However, it is likewise possible that the ions of the second ion type are released while the generation of ions of the first ion type proceeds essentially continuously. In this way, a higher constancy in the release of “fresh air” into the vehicle passenger compartment can be achieved. Furthermore, as a general rule the driving of the corresponding electrodes can be made simpler. According to the above proposal, it is also possible in at least one regeneration mode that no ions are released, at least at times, in particular no ions of the first ion type are released, at least at times. This can be realized, for example, by completely shutting off the ionization device. It has also been shown that a regeneration of the overall arrangement can take place even after relatively short time periods. Off periods in a range between 5 and 30 seconds are typically sufficient (with on periods in the normal operating mode of typically 30 seconds to 3 minutes). This solution is especially advantageous because it can be implemented by especially simple design means. In particular, this method can be used for ionization devices that have only a single high-voltage source and/or a single high-voltage electrode. In this context, especially fast regeneration can be realized in particular when relatively moist air is present, since this enhances rapid discharge of electrostatic accumulations.

The operation of the ionization device can be accomplished here by at least one control device for operating the ionization device. For example, a single-board computer or the like can serve as such a control device. It is possible here for a special control device to be provided for controlling the regeneration mode. However, it is likewise also possible for the functionality to be taken on by an electronic controller (for example an electronic controller for a motor vehicle climate control system) that typically is present in motor vehicles in any case. Since the computing load for a control device is typically relatively small, this additional workload generally does not represent a problem.

In addition, a climate control system, in particular a motor vehicle climate control system, is proposed that has at least one air conduction device with the above-described structure and/or at least one ionization device with the above-described structure. The climate control system then analogously has the characteristics and advantages already described in connection with the above-described air conduction device and/or the above-described ionization device. The vehicle for which the motor vehicle climate control system is intended can be a watercraft, an aircraft, and/or a land vehicle (rail vehicle/non-rail vehicle).

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a motor vehicle climate control system with an ionization device in a schematic cross-section;

FIG. 2 shows a time behavior of the ion concentration emitted into the vehicle passenger compartment by a conventional motor vehicle climate control system in a continuous operation method;

FIG. 3 shows a time behavior of the ion concentration emitted into the vehicle passenger compartment by a motor vehicle climate control system using a first type of regeneration method;

FIG. 4 shows a time behavior of the ion concentration emitted into the vehicle passenger compartment by a motor vehicle climate control system using a second type of regeneration method;

FIG. 5 is a first exemplary embodiment for an air duct with locally acting field compensation component in a schematic, perspective view;

FIG. 6 is a second exemplary embodiment for an air duct with locally acting field compensation component in a schematic, perspective view.

### DETAILED DESCRIPTION

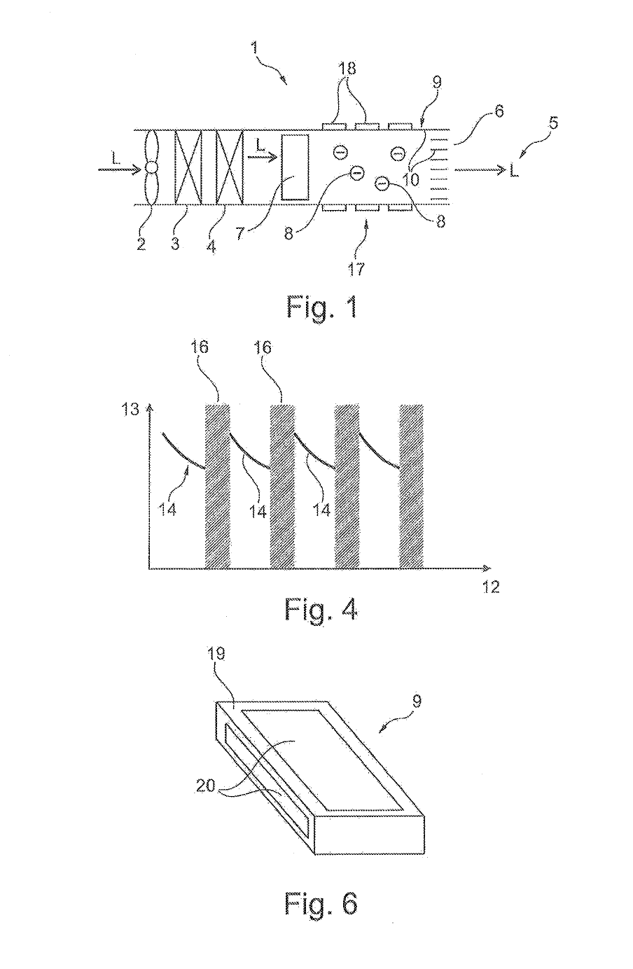

FIG. 1 shows a motor vehicle climate control system in a schematic cross-section. The motor vehicle climate control system 1 is shown here in a greatly simplified view that concentrates primarily on the areas that stand in connection with the air processing by ionization of the air flow L to be processed by the motor vehicle climate control system 1.

The air L that is drawn in by the motor vehicle climate control system 1 with the aid of a fan 2 is first passed through a filter 3 that filters out pollen, dirt particles, and the like, which may be contained in the ambient air. Then the air flow L is passed through a heater 4, and temperature-controlled accordingly (of course, the temperature control can also be accomplished by mixing hot and cold air; moreover, the air can also be cooled with the aid of an evaporator, etc.). Before the already largely processed air flow L is released through an air outlet nozzle 6 into a vehicle passenger compartment 5, it is first passed through an ionization module 7. Generated in this ionization module 7 are, for example, anions 8, which are perceived as “fresh air” by the vehicle occupants. The anions 8 generated by the ionization module 7 must first be directed through appropriately formed air ducts 9 and must flow through the air outlet nozzle 6. In this process, some of the anions 8 generated by the ionization module 7 strike the walls of the air duct 9 or the air outlet nozzle 6 and transfer their charge to the corresponding wall area 10. Over time, this results in an electrostatic charging of certain wall areas 10 of the air duct 9 and the air outlet nozzle 6. The electrostatic charging of the applicable wall areas 10 is not uniform, however, so that electric fields arise between wall areas 10 that are charged to different extents. The electric fields in turn influence the air flow L (in particular, the ions contained in the air flow L), in particular the path of motion of the anions 8 so that the system behaves in a manner that is extremely dynamic and difficult to predict.

As a general rule, however, the electrostatic charging of the wall areas 10 of the air duct 9 and the air outlet nozzles 6 causes a sharp reduction in the anions 8 that ultimately emerge into the vehicle passenger compartment 5 unless appropriate countermeasures are taken. Accordingly, the ionization module 7 would have to generate a correspondingly larger number of anions 8. For this purpose, the ionization module 7 would need to be designed to be correspondingly larger (which would cause it to be costlier and heavier), and a correspondingly greater amount of electric power would have to be provided for the ionization module 7. The decrease in the concentration of the anions 8 released into the vehicle passenger compartment 5 is shown schematically in FIG. 2 as the function graph 11 (if no separate means such as, e.g., special operating methods and/or design means are taken). In FIG. 2, the time t is represented along the abscissa 12, while the ion concentration that is released into the vehicle passenger compartment 5 is plotted along the ordinate 13. The sharp decrease in the ion concentrations is readily evident. Typically, after a period of 1 to 5 minutes only every tenth anion 8 that is generated reaches the vehicle passenger compartment 5. The effect is thus extremely significant.

In order to increase the average over time of the concentration of anions 8 released into the vehicle passenger compartment 5, it is proposed to provided design means that, because of their properties, increase the proportion of anions 8 (or of other ions) released into the vehicle passenger compartment 5 as compared to standard motor vehicle climate control systems.

One possibility for such a design means includes, for example, of a grid 17 of metal films 18, each of which are spaced apart from one another, in the arrangement already indicated in FIG. 1. Possible details concerning the position and arrangement of the metal films 18 on the air duct 9 are also evident in FIG. 5. As is evident, a uniform grid of identically shaped metal films 18 is used in the exemplary embodiment shown in the present case. The individual “columns” of the grid here are each offset relative to one another, so that the metal films 18 are in a sense “spaced out” relative to one another. The metal films 18 are designed as self-adhesive metal films, and are adhered to, e.g., the already built air duct 9 (which was made from plastic using an injection molding method, for example). As is evident from FIG. 1 and FIG. 5, the metal films 18 are located on the outside 19 of the air duct 9 in this case.

In the exemplary embodiment shown in the present case, the metal films 18 are each arranged to be electrically insulated from one another and, moreover, are not grounded. In another conceivable exemplary embodiment, it is also possible for the metal films 18 (or a portion thereof) to be electrically connected to one another (possibly through high-resistance electrical conductors) and/or connected to ground potential (possibly through a high-resistance electrical conductor).

Independent of the specific detailed design, it has become evident that the locally limited mobility of charge carriers in the individual metal films 18 has the effect that mirror charges can arise over a limited distance in the metal films 18, which mirror charges can correspond to electric charges or charge clusters on the inner wall areas 10 and/or in the interior of the air duct 9. The mirror charges thus produced cause a reduction or advantageous redistribution of the electric fields that are present, which can ultimately result in a higher fraction of anions 8 passing through the air duct 9 (without said anions being lost at the wall areas 10 of the air duct 9 or the air outlet element 6). In this way, the discharge of anions 8 into the vehicle passenger compartment 5 can be improved.

Another possible exemplary embodiment for a device that achieves such a locally acting field compensation is shown in FIG. 6. An air duct 9 is again shown here in a schematic, perspective view. Provided on the outsides 19 of the air duct 9 are so-called ESD films 20, which are applied over large areas. In the exemplary embodiment shown in the present case, the ESD films 20 are designed as self-adhesive films that are adhered to the already built air duct 9. Because of the poor electrical conductivity as compared to metal foils—but good electrical conductivity as compared to electrical insulators—a local compensation of electric fields that arise also results here, wherein this compensation only arises in a relatively tightly limited surface area. This appears to behave such that over relatively short spatial distances (for example, a few centimeters), the electrical resistance of the ESD film 20 does not have a negative effect on the formation of mirror charges. In contrast, over relatively long spatial distances (e.g., 10 centimeters or more) the electrical resistance of the ESD films 20 appears to effectively pose an obstacle to the motion of electric mirror charges and thus an obstacle to the compensation of the electric fields. Another possible explanation for the properties of the ESD film 20 is that the ESD film 20 has only a low longitudinal conductivity. This only low longitudinal conductivity permits an image charge that has strong local variation (even across short distances), or the only low longitudinal conductivity makes it possible for surface charges with strong local variation to be dissipated. In the exemplary embodiment from FIG. 6 shown in the present case, it is also possible for the individual (possibly high-resistance) ESD films 20 to be electrically connected to one another and/or (through high-resistance connecting lines) to ground.

Although a significantly increased ion concentration can be discharged into the vehicle passenger compartment 5 in comparison with standard motor vehicle climate control systems simply by the use of the proposed design measures (thus, for example, the application of metal films 18 and/or ESD films 20; see FIG. 5 and FIG. 6), it is advisable to provide a special method of operating the motor vehicle climate control system 1 in addition to the proposed design measures (or, if applicable, in addition to other possible design measures) in order to further increase the average over time of the concentration of anions 8 discharged into the vehicle passenger compartment 5.

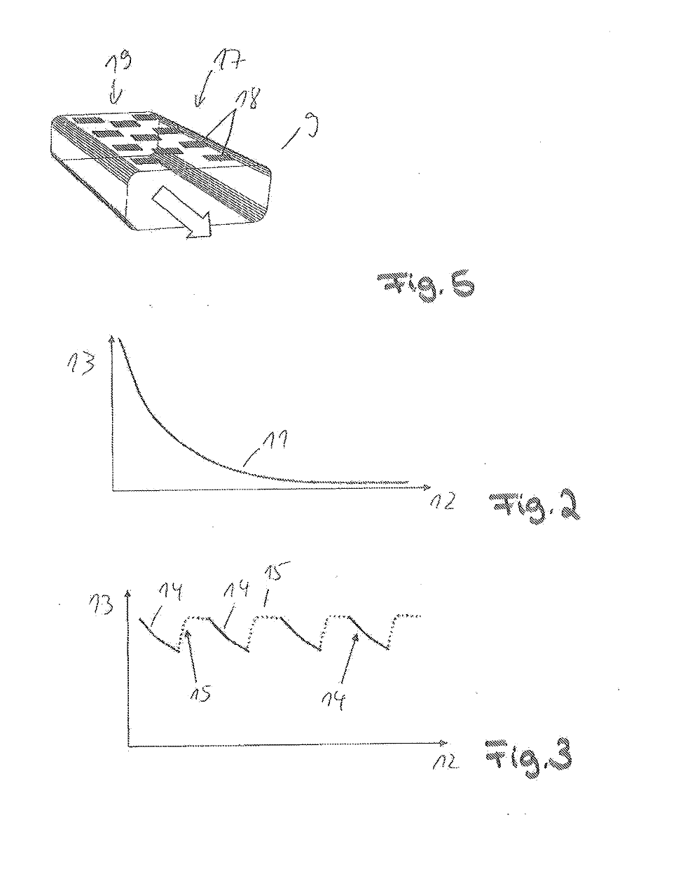

In order to increase the average over time of the concentration of anions 8 discharged into the vehicle passenger compartment 5, it is possible, for example, to operate the ionization module 7 in a normal operating mode 14 (see also FIG. 3) only for a certain period of time (typically 1 to 3 minutes). After a certain period of time has elapsed, the motor vehicle climate control system 1 is switched to a regeneration mode 15, in which not only anions 8 are generated (as shown in FIG. 1), but in which cations are additionally generated by the ionization module 7 (which must be appropriately designed for this purpose). In the present exemplary embodiment shown, the cations generated by the ionization module 7 are only generated “temporarily” and serve only to generate a second ion type, which in the present case is likewise anions 8 (albeit of a different ion type as well). The “alternating” generation of different ion types causes a discharge of the statically charged wall areas 10, so that because of the regeneration phase 15, the concentration of anions 8 discharged into the vehicle passenger compartment 5 not only does not decrease further, but rather can increase again. After the termination of the regeneration phase 15 (which typically lasts 5 to 30 seconds), another normal operating mode 14 follows, which in turn is followed by a regeneration phase 15, etc. This method is shown in FIG. 3. Here, too, the time is represented along the abscissa 12, while the concentration of anions released into the vehicle passenger compartment 5 is plotted along the ordinate 13.

A second possible method for operating an ionization module 7 resides in that the ionization module 7 is first operated in a normal operating mode 14—in similar fashion to the preceding exemplary embodiment (cf. FIG. 4). After a certain time period has elapsed (typically 1 to 3 minutes), the ionization module 7 is regenerated 16 by the means that the ionization module 7 is simply switched off, and thus no ions (in particular, no anions 8) are generated. During this regeneration phase 16, the static charges along the wall areas 10 of the air duct 9 and the air outlet nozzle 6 can likewise dissipate, for example due to the humidity typically present in the air flow L. The duration of the regeneration phase is typically 5 to 30 seconds. At the end of the regeneration phase 16, operation in a normal operating mode 14 follows, regeneration 16 is carried out again by switch-off, etc. The method described is illustrated in detail in FIG. 4. Here, too, the time is represented along the abscissa 12, while the concentration of anions 8 released into the vehicle passenger compartment 5 is plotted along the ordinate 13.

Additional information can be obtained from the patent application entitled “Verfahren zur Ansteuerung einer lonisierungsvorrichtung” [Method for operating an ionization device], which was filed with the German Patent and Trademark Office by the same applicant and on the same day under the applicant's file number 09-B-110-1. The disclosure content of this patent application is incorporated in full in the disclosure content of the present application document.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An air conduction device for an ionization device, the air conduction device comprises, at least in sections, at least one locally acting field compensation component.

2. The air conduction device according to claim 1, wherein at least one locally acting field compensation component is configured, at least in sections, as a plurality of electrically conductive material segments.

3. The air conduction device according to claim 2, wherein the electrical conductivity of at least one electrically conductive material segment is greater than or equal to 10⁴ S/m, 10⁵ S/m, and/or 10⁶ S/m.

4. The air conduction device according to claim 1, wherein at least two locally acting field compensation components or at least two electrically conductive material segments are electrically decoupled from one another.

5. The air conduction device according to claim 4, wherein the electrical decoupling has, at least in part, a conductivity of less than or equal to 10⁵ S/m, 10⁴ S/m, 10³ S/m, 10² S/m, 10¹ S/m, and/or 10⁰ S/m.

6. The air conduction device according to claim 1, wherein at least one locally acting field compensation component is configured, at least in sections, as a continuous, slightly electrically conductive component.

7. The air conduction device according to claim 6, wherein at least one slightly electrically conductive component has, at least in sections, an electrical conductivity of less than or equal to 10⁵ S/m, 10⁴ S/m, 10³ S/m, 10² S/m, 10¹ S/m, 10⁰ S/m, 10⁻¹ S/m, 10⁻² S/m, 10⁻³ S/m, 10⁻⁴ S/m, and/or 10⁻⁵ S/m.

8. The air conduction device according to claim 1, wherein at least one locally acting field compensation component or at least one electrically conductive material segment and/or at least one slightly electrically conductive component is configured to be flat or in the form of a film.

9. The air conduction device according to claim 1, wherein at least one locally acting field compensation component or at least one electrically conductive material segment and/or at least one slightly electrically conductive component is configured to be self-adhesive.

10. An ionization device having at least one first ionization component for releasing ions of a first ion type, at least at certain times, and having at least one air conduction device according to claim 1.

11. The ionization device according to claim 10, wherein the ionization device is configured such that it is operated in at least one regeneration mode, at least at times.

12. The ionization device according to claim 10, wherein, in at least one regeneration mode, ions of a second type different from the first ion type are released at least at times, and/or no ions of the first ion type are released at least at times.

13. A climate control system for a motor vehicle, comprising at least one air conduction device according to claim 1 and/or at least one ionization device.

14. The air conduction device according to claim 1, wherein the air conduction device is an air conduction channel and/or air outlet nozzle.
